(19) United States
(12) Patent Application Publication
(10) Pub. No.: US 2006/0174243 A1
(43) Pub. Date: Aug. 3, 2006

(54) Application software installation prequalification system and method

(76) Inventors: Gregory Brewer, Brighton, MI (US); John McMillan, Milford, MI (US)

Correspondence Address: ADVANTEDGE LAW GROUP, LLC, 1928 E. COBBLESTONE RD., SUITE 100, SPRINGVILLE, UT, 84663, US

(21) Appl. No.: 11/046,670

(22) Filed: Jan. 31, 2005

(51) Int. Cl. G06F 9/445

(52) U.S. Cl. 717/174

(57) ABSTRACT

A system and method is used to identify and resolve issues that may prevent a software application from being properly installed in a target environment. A diagnostic tool kit provides a set of custom actions that a packager could use to instrument their package to return information about the status of the install. These actions send the data back to a repository for storage. Package instrumentation analyzes a package and generates a streamlined package containing only the components required to simulate an install and custom actions from the diagnostic tool kit. System administrators are able to specify which diagnostic actions they want included in the generated package. Once the package has been generated, the system administrator can deploy it across the intended machines. As the package installs it simulates an actual install on a target machine. Diagnostic custom actions are executed and the results will be sent to the repository for later analysis and reporting. The reporting system allows the system administrators to see a summary report on the deployment, and drill down to examine any specific problems that occur.

### FIELD OF THE INVENTION

This invention relates generally to software installation and, in particular, to a system and method for testing a software application prior to actual installation.

### BACKGROUND OF THE INVENTION

The Microsoft® Windows® Installer (MSI) is a significant improvement regarding the way in which software applications are installed and managed. MSI solves problems associated with installing applications, including .DLL incompatibility, inconsistent behavior of setup programs, lack of proper uninstall and rollback support.

Previous setup programs did little more than copy files and write registry entries, often with little or no regard for what else might already be installed on the system. MSI changes the way applications install by dividing applications into entire applications, modules within applications, and functional units such as .DLL's, registry entries, and so forth, and treats the various components appropriately.

Key features of Windows Installer include the management of shared files via components; self-repair of components; cleaner uninstall procedures; roll-back support for failed installations, and other utilities. In terms of architecture, MSI is essentially a database, describing how an application installs, and dividing it up into the component parts discussed above. The MSI, in conjunction with application source files, contains all the information about an application. The database format is recorded on the target machine at install time, such that information necessary to repair the application is always available.

Many professional software developers rely systems such as the Wise for Windows Installer to quickly and easily create reliable .MSI installations. With exclusive features for development teams of any size, the Wise for Windows Installer gives developers the tools needed to create any type of installation, including desktop, server, Web, or mobile applications.

As part of the system, Installation Expert and MSI Script™ provide flexible options for creating high-quality installations. Installation Expert walks a user through the creation of an .MSI installation, allowing views of the installation in script format with MSI Script. Customization is easy with expanded dialog editing and installation themes. Tedious tasks associated with server installations, such as writing documents to help end-users try to manually configure servers, or writing extensive code to handle complex interaction with end user environment, are no longer required. The system can add and manage users, configure the SQL Server, and take advantage of advanced support for Microsoft Internet Information Server (H1S) installations.

WiseScript supports a Test compilation mode where none of the actual file bits are stored in the installation EKE. There is an exception for files that will be placed in the % TEMP % directory as these files can sometimes be DLLs that are called by the installation. This mode is not required for pre-flight but it is recommended to reduce the size of the test package.

WiseScript supports status MIF creation at the end of an installation. This file is normally created in the Windows directory. The user has to fill out the Status MIF fields to have this file generated. This status MIF file is created during a full installation as well as a test installation.

WiseScript installations support the /T command line switch to run the installation in “test” mode. While in this mode the installation is run but no permanent changes are made to the target computer. To make sure that a proper test is performed, file installations will actually create a temporary file in the destination folder to make sure it is writable, an access check is performed on the actual destination file as well. A similar function is performed on registry keys and other system changes. These temporary changes are removed right after they are created.

If there is an error during any of the test mode checks and a status MIF is enabled, the error information is placed into the status MIF file. This file is normally returned to the administrator via their distribution system (i.e. Altiris or SMS).

### SUMMARY OF THE INVENTION

This invention improves upon the existing art by providing system administrators with a system and method to identify and resolve issues that may prevent a software application from being properly installed in their environment. The preferred embodiment includes several components. A diagnostic tool kit provides a set of custom actions that a packager could use to instrument their package to return information about the status of the install. These actions send the data back to a repository for storage.

Package instrumentation analyzes a package and generates a streamlined package containing only the components required to simulate an install and custom actions from the diagnostic tool kit. System administrators are able to specify which diagnostic actions they want included in the generated package.

Once the package has been generated, the system administrator can deploy it across the intended machines. As the package installs it simulates an actual install on a target machine. Diagnostic custom actions are executed and the results will be sent to the repository using the SOAP protocol. The repository saves these records in an SQL Server backend for later analysis and reporting.

After the deployment has been completed the system administrator is able to analyze the results using the reporting system. The reporting system allows the system administrators to see a summary report on the deployment, and drill down to examine any specific problems that occur.

### BRIEF DESCRIPTION OF THE DRAWINGS

FIG. 1 is a is a diagram that shows steps used to create and deploy a preflight package;

FIG. 2 shows a SOAP message XML schema for the definition of the SOAP message; and

FIG. 3 is a database ER diagram for the database layout.

### DETAILED DESCRIPTION OF THE INVENTION

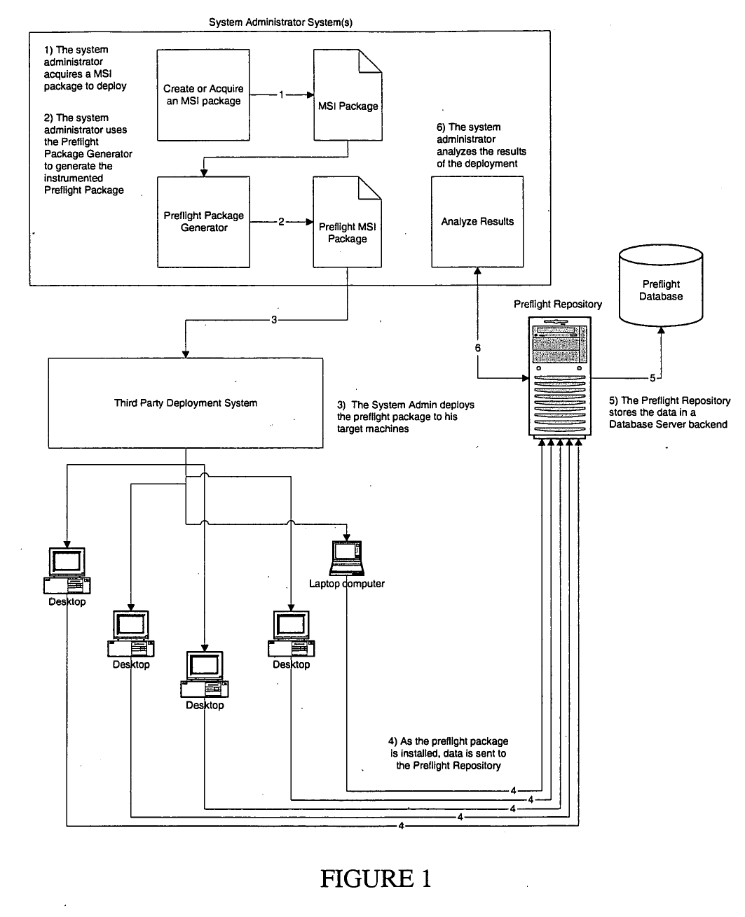

This invention, called Preflight™ system makes it easy for system administrators to determine if their packages will successfully deploy software application requirements on a target machine. FIG. 1 shows steps used to create and deploy a preflight package.

The system administrator acquires a Microsoft® Windows® Installer (MSI) package that they want to distribute to one or more target machines. They can use any MSI with the Preflight system (Step 1).

The system administrator then uses a Preflight package generator to create a preflight package from the original MSI. The system administrator is able to select from a set of predefined diagnostic customs action that they want automatically added to the Preflight MSI. After the user makes their choices, the Preflight generator generates the preflight MSI file (Step 2).

Now that the system administrator has a Preflight MSI, they can deploy it to the target machines using their deployment tool (Step 3). As the package is deployed the diagnostic custom action will be executed and the results, preferably in XML form, are sent to the Preflight repository (Step 4).

When the Preflight repository receives a message from a Preflight package, it processes the XML and stores the record in an SQL server database (Step 5). This allows the system administrator to easily view and analyze the results of the Preflight test.

Once the preflight test run has finished, the system administrator can use the Preflight repository's reporting web interface to view and analyze the results. They see a summary of the full results for a test, and are able to drill down to further examine any issues that are discovered (Step 6).

Diagnostic Tool Kit

The diagnostic tool kit includes custom actions that check for various conditions and reports them back to the preflight repository. The diagnostic tool kit custom actions are implemented in a new custom action DLL that can be used with package studio and WFWI.

The custom actions use the Windows installer API and Windows API calls to perform the actions. The actions construct an XML document containing the results of the action which is sent to the Preflight repository using the SOAP protocol.

The diagnostic tool kit custom actions are integrated in the WFWI MSI Script tab. New diagnostic custom actions may be inserted in the execution sequences and will function in conjunction with the existing custom actions.

Preflight Instrumentation

While the system administrator could manually instrument an MSI, Preflight instrumentation greatly simplifies the process. Preflight instrumentation analyzes a MSI package and instruments it with custom actions from the diagnostic tool kit. It removes any embedded cab files that are included in the original MSI files. It also removes entries from the MSI database tables that are not required by the Preflight MSI.

A wizard-based UI walks the user through the process of generating a preflight package. The system administrator selects the original MSI file to instrument, the full path of the generated preflight MSI file, the server name, and path of the preflight repository.

Preflight instrumentation includes an understanding of the installation sequence to determine where these custom actions should be inserted in the MSI.

Preflight Data Collector

The Preflight repository is a plug-in to the Wise Web Service (see www.wise.com, the entire content of which is incorporated herein by reference). It is responsible for processing the XML documents sent from the preflight tool kit custom actions and storing the documents into database tables. It receives the XML document using the SOAP protocol, parses the XML document, and updates the SQL Server backend.

Preflight Reporting System

The Preflight reporting system allows system administrators to examine the results of preflight runs. The system administrator may connect to the system using the Wise Package Studio (see www.wise.com/wps.asp, the entire content of which is also incorporated herein by reference). Users are presented with a list of preflight packages that have been deployed along with a status of the deployed package.

ASP is used to provide a flexible, dynamic web based user interface to the preflight data. ADO provides the connection to the SQL server backend. The reporting system first generates an XML file from a SQL query and then formats the XML using XSLT.

### Diagnostic Tool Kit

Begin Run

(MarkBeginRun)

This diagnostic indicates the beginning of the preflight test. This test also checks to determine if the application that the preflight package is testing is already installed. The Preflight instrumentation will change the package code during the instrumentation and save the original package code in a property that the BeginRun diagnostic will use to determine if the original package is already installed.

Possible Status Codes

Informational Always

Messages

Begin of Diagnostic Run

Begin of Diagnostic Run (failed because the product is already installed)

Launch Conditions

(CheckLaunchCondition)

The CheckLaunchCondition custom action determines which launch conditions succeed and which fail. It enumerates the LaunchCondition table and evaluates the condition using the MsiEvaulateCondition API function.

During preflight instrumentation the system determines if any actions are removed in the InstallExecuteSequence before the LaunchCondition action. If actions were removed, it will be unable to determine if the Launch condition failed because of the removed action or if it fails due to the condition. Preflight Instrumentation sets the property WISEDAIGLAUNCHWARN to 1 to indicate that this is the case.

Possible Status Codes

| | |
|---|---|
| Success | If all launch conditions succeed |
| Failure | If any launch condition fails, unless an action is removed |
| | before the launch condition check |
| Warning | If any launch condition fails and an action was removed by |
| | preflight instrumentation. |
| Messages | |

Checked % d launch conditions, % d passed, % d failed

Item Messages

| Condition | Description | Pass/Fail |
|---|---|---|
| Condition | No condition was checked | Fail |
| Condition | Invalid Condition | Fail |

.NET Framework
(CheckDotNet)

The CheckDotNet diagnostic custom action will determine if the .NET is required by this install, and if so, if the dot net framework is installed on the target PC.

The package generator determines if this check is required by checking the MsiAssembly table for any entries with a ‘0’ in the ‘Attributes’ column. If the check is not required the package generator will not insert this check.

The test first ensures that there is a dot net assembly in the package. It then retrieves from the registry the versions of dot net that are installed, if a version of dot net is installed it return success and lists the versions installed, if no version is installed the test fails. This check will be inserted after the launch condition check.

Possible Status Codes and Messages

| Status code | Message |
|---|---|
| Failure | The dot net framework is required for this installation but |
| | no version of the framework is installed |
| Success | The dot net framework is required for this installation and |
| | versions 1.0 and 1.1 of the framework are installed |
| | The dot net framework is required for this installation and |
| | version 1.0 of the framework is installed |
| | The dot net framework is required for this installation and |
| | version 1.1 of the framework is installed |

The following message will not show up unless the check is inserted manually (not possible for WPS 5.0)
Informational The dot net framework is not required for this installation
Connectivity to URL
(LaunchWeb)

During Preflight Instrumentation the LaunchWeb diagnostic extracts URLs from the DisplayURL, DownloadFile and PostToHttp custom actions. It puts them in a table, WiseUrlDiag, which is processed on the client machine.

First the test ensures that the connection can be opened to the specified URL, the content is then download. The test then translates the result into text.

Possible Status Codes

| | |
|---|---|
| Success | if all the content from all URLs were able to be successfully |
| | download |
| Failure | if any URL failed. |

Messages

“Tests passed: % u Tests failed: % u”, m_Passed, m_Failed

Item Messages

“Successfully downloaded % s.”, host

“Connection to % s was successful, but downloaded failed.”, host

“Network route to % s is possible, but connection attempt failed.”, host

“Error processing % s.”, host

Error text and code is appended to appropriate messages, if available from the OS:

“Error: % s (code % u)”, errorText, errorCode

Open Document Check

(OpenDocExtCheck)

During Preflight instrumentation, OpenDocExtCheck builds a list of document extensions from the OpenDocument custom action, and saves the list in the WiseExtDiag table. On the client, the diagnostic checks the registry for support for each extension.

This test tries to open the registry key associated with the extension, if it successfully opens the key then an association exists otherwise no extension exists

Possible Status Codes

| | |
|---|---|
| Success | All extensions have associated applications |
| Warning | At least one extension does not have an associated application |

Messages
Checked % d extensions, % d have associated applications, % d do not have associated applications
Item Messages

The extension % s has no associated program

File Association Check

(FileAssociationConflict)

The FileAssociationConflict check processes the Extension table and checks the registry for support for each extension. This test opens the registry key for the extension. If the key exists then the extension is already registered. The existing value of the key is compared with the ProgId to be registered; if they match then the same application is reregistering the same extension. If they do not match, the application being installed is overwriting the existing extension. If the key is empty then the extension is registered but no application is associated with the extension.

Possible Status Codes

| | |
|---|---|
| Success | There is no conflicting file association registered |
| Warning | At least one file association is conflicting with a file |
| | extension that is already registered |
| Informational | An extension is already registered but there is not |
| | associated application |

Message
% d Total file associations checked, % d Possible conflict(s) found

Item Messages

| | |
|---|---|
| Extension | The extension % s that is to be associated with % s conflicts |
| | with the existing registration of % s to % s |
| Extension | The extension % s that is to be associated with % s conflicts |
| | with the existing registration of % s. However there is no |
| | existing associated application |

Disk Space Check
(CheckDiskSpace)

CheckDiskSpace evaluates the disk costing and identifies machines that don't meet the requirements. MsiVerifyDiskSpace is used to calculate the costing and validate the amount of disk space. The following properties are used to display the amount of disk space required and available on the destination machine:

PrimaryVolumePath

PrimaryVolumeSpaceAvailable

PrimaryVolumeSpaceRequired

PrimaryVolumeSpaceRemaining

Possible Status Codes

| | |
|---|---|
| Success | Enough disk space exists to install the application |
| Failure | There is not enough disk space to install the application |

Message
Primary Volume % s, Space Available % d, Space Required % d, Space Remaining % d
File Security/Registry Security
(SecurityCheckFileRead/SecurityCheckFileWrite)
(SecurityCheckRegistryRead/SecurityCheckRegistryWrite)

These checks iterate through the files or registry keys and values that can be installed by the MSI and query the system for permissions to create, access and update files or values.

A list of securable objects is built from the File and Registry MSI tables. For objects that exist, the test reads the security descriptor. For each profile on the system (read tests) or the installer's account (write tests), the test reads each security descriptor's access control list and determines the users level of access to the object. For objects that do not exist, i.e. objects that will be installed, the parent's access control list is used to determine the access level. The test also reads and applies information from the MSI LockPermissions table to gather additional security information (read test only)

Possible Status Codes

| | |
|---|---|
| Success | The user can read (and write for write tests) all items |
| | checked. |
| Warning | For a read test - the user can read an item |
| Failure | For write test - the user cannot read or write an item |
| Informational | The user has no permission to read a security descriptor |

Messages
Checked access privileges on % d file(s) for % d user(s), % d of % d check(s) failed.
Checked access privileges on % d registry key(s) for % d user(s), % d of % d check(s) failed.
Item Messages

Only items that failed the test are displayed

Item Name Domain Name User Name

File Searching

(AppSearch)

The File Searching diagnostic test enumerates the entries in the App Search table and evaluates the expressions using the MSIEvaluate Property function. It then retrieves the value of the property and reports the results.

Possible Status Codes

Informational—Always

Messages

% d App Search entries evaluated

Item Messages

App Search Property Item Exists Value

Local File Execution

(CheckExecuteLocally)

This check evaluates type 34 or type 50 custom actions, which launch a file that is expected to exist on the client PC. The only difference between the type 34 and type 50 actions is the way that the application path is specified. For type 34 the application path is specified in with the parameters in the custom action table and for type 50 the application name is specified by the property name in the custom action table. It is possible that the application name cannot be determined if some custom action that was removed is setting a property used to specify the application name.

Once the test obtains the application path and ensure that it is valid, it calls load library to ensure the application can be loaded, and returns success if the application loaded, failure if not.

Possible Status Codes

| | |
|---|---|
| Success | All applications could be loaded |
| Warning | At least one application name could not be determined |
| Failure | At least one application could not be loaded |

Message
% d Execute locally commands checked, % d programs found, % d programs not found
If unknown file names exists, the following string is appended:

,unable to determine the file name for % d

End Run

(MarkEndRun)

This diagnostic indicates the end of the preflight test. It indicates the MSI was fully processed. Preflight Analysis uses the MarkEndRun test to determine if a run in incomplete.

Possible Status Codes

Informational—Always

Messages

End of Diagnostic Run

### Preflight Package Instrumentation

The Preflight package instrumentation engine analyzes an MSI package and instruments it with custom actions from the diagnostic tool kit. It removes any embedded cab files that are included in the original MSI files. It also removes entries from the MSI database tables that are not required by the Preflight MSI.

When the Preflight package instrumentation engine launches, it collects the following information from the user:
Source Installation MSI name and location
Preflight MSI name and location
URL for the preflight data collector web service
The Job ID that this preflight package should be associated with

The Preflight MSI name and location is derived from the source installation name and location. The URL for the Preflight data collector is persisted between sessions so the user only has to enter this information once, if the are sending the information to the same server. The Job Id is derived from the last preflight instrumentation and incremented by 1.

Once this information has been gathered, the engine creates the instrumented preflight MSI. If any of the following steps occur, the preflight instrumentation is aborted and the error is reported to the user.

First the engine creates a temporary MSI database to perform the instrumentation. If the source MSI did not contain a custom action table, the engine creates one so it can insert the preflight diagnostic tests. It then sets the WISEDIAGSERVER property to the url that was specified by the user.

Once the temporary MSI has been created and setup, the engine enumerates the tools from the diagnostic tool manger. Every tool is asked to prepare itself for being inserted into the Preflight MSI. In response some tools save information from the Source MSI that may be removed during instrumentation. Other tools, (i.e. .Net Framework) determine if they are needed for this source MSI. For each tool in the tool manager the engine retrieves the location to insert the diagnostic test in the Execute Sequence. The engine renumber the existing execute sequence if necessary to insert the diagnostic test custom actions.

After the diagnostic tools have been inserted into the execute sequence, the engine starts to strip out unnecessary information form the preflight MSI. First the UI bitmaps are removed form the Binary table, and then any custom action that the engine has determined is not safe is removed. And finally any tables that are not required during the execution of the preflight MSI are removed, including Cabs, Streams, Dialog, Control among others.

Once everything that is not necessary for the Preflight package has been stripped out, the engine sets up properties that are required for the proper operation of the preflight package. The engine sets the WISE_JOB_ID to the job id the user specified, EXECUTEMODE to none, ARPNOREMOVE, ARPNOMODIFY and ARPNOREPAIR to 1. And if the log file was specified on the command line sets PREFLIGHTLOG to the log file. It then updates the product code to prevent conflicts with a already installed product. It then disables any reboots that the source MSI would have preformed. The system then saves and compresses the Preflight package.

### Data Collector Web Application

When a preflight diagnostic custom action is run on the client computer, it sends the results of the test to the data collector web service. SOAP is the protocol that is preferably used to send the results to the web service.

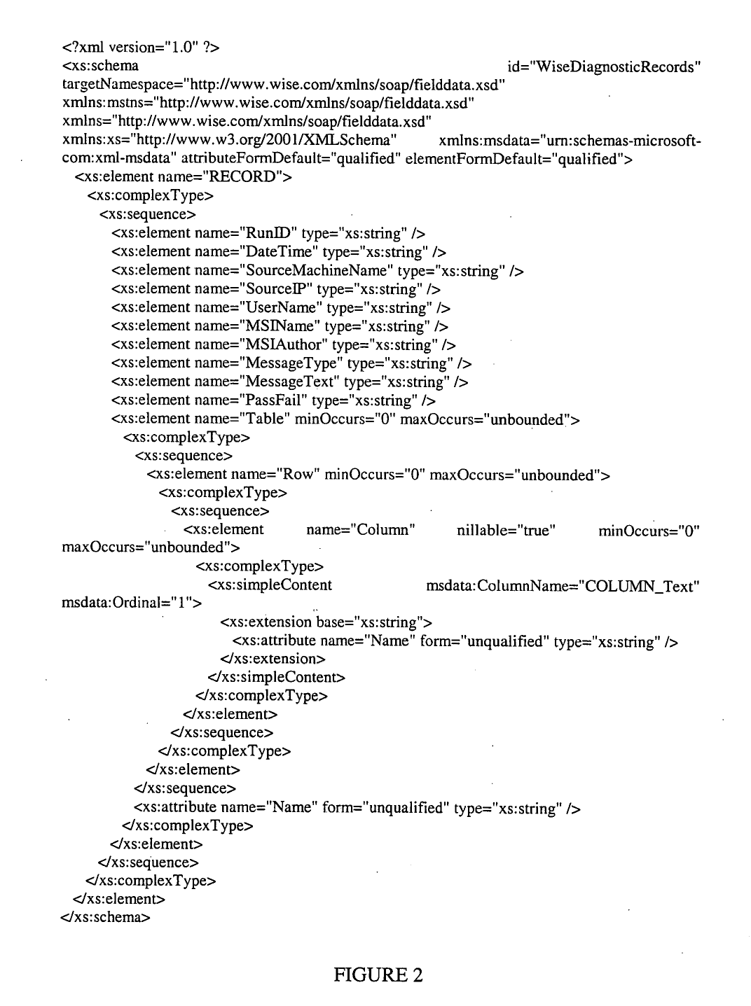

The test performs its work and then uses the results to build the body for the XML message. FIG. 2 provides a SOAP message XML schema for the definition of the SOAP message.

The custom action first gets the URL of the data collector web service from the WISEDIAGSERVER property. It then creates a worker thread to send the message while still processing messages. The action then waits until the SOAP message has been delivered to the server and then exits. If any errors occur they are logged if logging is turned on.

Send Message Worker Thread

The message thread is responsible for actually sending the SOAP message to the server. The main thread of the diagnostic custom action passes the XML body and file attachments names and the URL of the data collector web service.

The worker thread then creates a SOAP header for the message, it then adds the XML body to the SOAP message that was prepared by the main thread. Any file attachments are then added to the message.

Once the SOAP message has been created, the worker thread opens a HTTP connection to the Data Collector web service and posts the SOAP message to the server. Once the message has been delivered the HTTP connection is closed. If any error occurs it is logged if logging has been turned on.

Wise Web Service

The Wise Web Service is responsible for receiving SOAP messages and routing requests to the proper Wise web application. This service is not specific to the Preflight system but is used by the Preflight data collector to receive data.

When the Wise Web service receives a SOAP message it first checks to ensure that the SOAP message that it has received is valid. Once it determines that the message is valid, it determines which Wise Web application the message should be routed to and routes the message to it. Once the message has been processed by the appropriate web application the Wise Web Service sets the http status code and returns any reply message.

Preflight Data Collector

The preflight data collector is a plug-in to the Wise Web Service. It is responsible for processing the SOAP message that the diagnostic custom action sends.

When the Preflight data collector receives an XML Document it parses the document building in memory data stores, which are used in later steps of the processing of the message. Once the data stores have been populated the data collector updates the Run and StdBoy tables with the general information about the test results. After the standard tables have been populated any custom tables specific to the specific type of diagnostic action are populated. Any attachments are added to the database and saved to the sharepoint. If any errors occur during the processing of the SOAP message the error is logged if logging is enabled.

### Preflight Repository

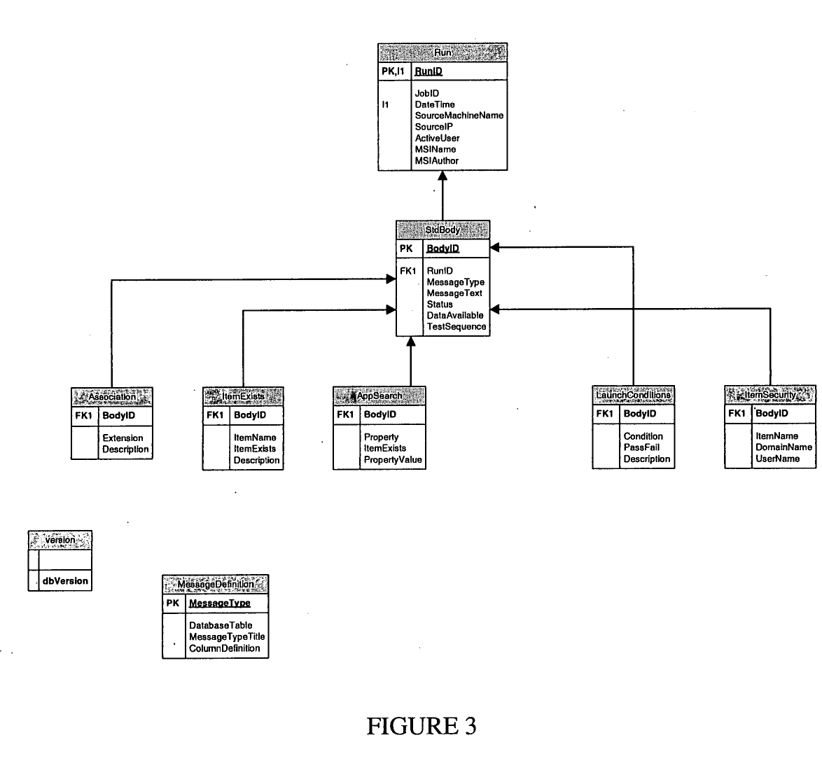

The Preflight repository is an SQL server database used to store all of the information about any preflight tests that where run. A description of the tables and columns is listed below. FIG. 3 is a database ER diagram for the database layout.

MessageDefinition Table

The Message Definition table is used to define the database information that relates to each message type.

Message Definition Columns

| | |
|---|---|
| MessageType | The diagnostic custom action message type |
| DatabaseTable | The table in which message specific information |
| | is stored. Can be NULL to indicate there is no |
| | message specific information |
| MessageTypeTitle | The display text for this message type |
| ColumnDefinition | The select clause for the message specific |
| | information from DatabaseTable. |

Version Table

The version table is used to specify the version of the current database. This is used during the install and upgrading process.

Version Columns

DbVersion The Current version of the database.

Run Table

The Run Table contains summary information about a set of results from a machine. Run Columns

| | |
|---|---|
| RunID | The RunID associated with the current run |
| JobID | The Job ID associated with the results |
| DateTime | The datetime that the test were started |
| SourceMachineName | The machine for which the results were send from |
| SourceIP | Future Use |
| ActiveUser | The user that the preflight test ran under |
| MSIName | The name and location of the MSI |
| MSIAuthor | The author of the MSI |

Standard Body Table

The Standard Body table stores the results of a specific instance of a test run

| | |
|---|---|
| BodyID | An auto number unique identifier to identify data |
| | belonging to a specific test instance. - Primary Key |
| RunId | The Associated Run Id |
| MessageType | A identifier for the type of message |
| MessageText | Information about the results of the test performed. |
| Status | The Status of the test, (Pass = 1, Fail = 255, |
| | Warning = 128, Informational = 0) |

DataAvailable Specifies if there is additional data in other tables relating to this test.
TestSequence The sequential order that this test was run within the run.
App Search

The App Search table stores detailed information about the AppSearch diagnostic custom action.

| | |
|---|---|
| BodyID | The BodyId that the information in this record |
| | is associated. |
| Property | The property checked |
| ItemExists | “1” if property could be resolved, “0” if not |
| PropertyValue | The value of the property is it could be resolved |

Association

The Association table stores detailed information about the FileAssociationConflict diagnostic custom action.

| | |
|---|---|
| BodyID | The BodyId that the information in this record is associated. |
| Extension | The file extension that was checked for conflicts |
| Description | The result of the conflict check |

Item Exists

The Item Exists table stores detailed information about the OpenDocExt, CheckExecuteLocally, and LaunchWeb diagnostic custom actions.

| | |
|---|---|
| BodyID | The BodyId that the information in this record is associated. |
| ItemName | The name of the item tested |
| ItemExists | “1” if the item exists and “0” if not |
| Description | Any additional information about the test |

Item Security

The Item Security table stores detail information about resources that cannot be accessed. The File and Registry Security diagnostic custom actions use this table.

| | |
|---|---|
| BodyID | The BodyId that the information in this record |
| | is associated. |
| ItemName | The name of the resource that can not be accessed |
| DomainName | The domain name of the user |
| UserName | The user name of the user unable to access the resource |

Launch Conditions

The Launch condition table stores detail information for the Launch Condition diagnostic custom action.

| | |
|---|---|
| BodyID | The BodyId that the information in this record is associated. |
| Condition | The Launch Condition that was checked |
| PassFail | “1” if the launch condition passed, “0” if not |
| Description | Any additional information about the test |

### Preflight Analysis

To analyze the results of a preflight job, users access the Preflight analysis web application, which shows detailed results for every machine that the preflight package ran. For each machine, users are able to drill down and see the results of every individual tests that were run on that machine.

The Preflight analysis server is implemented as a set of ASP pages. The ASP pages retrieve the data required to display the page from the Preflight repository and produces a XML document representing the data. It then applies an XSL transform to this XML document to produces the HTML page.

The main pages of the Preflight analysis web application are detailed below:

Preflight Job List

The Preflight Job List shows a list of all preflight jobs that have results associated with them. For each job, the page lists the job name, the number of machines reporting results, the date and time of the first and last results for that particular job. The user can sort by any of these columns by clicking on the column heading.

From each job the user can drill down and see the details for that job. If there are more jobs than can be displayed on the page the user can page through the list of jobs.

Job Summary

On the Job Summary page, the user is able to view the detailed summary information about the status of a job. The user can also delete the job from the database from this page. This removes all results from the database related to this job. The user can also return to the Preflight Job List page.

In the header of the page the name of the job, the path where the MSI was run from, the date and time of the first and last result and the number of machines reporting results are summarized.

The results for each diagnostic test run are categorized by status code: Passed, Warnings, Failures and Incomplete, along with the total number of results. The information for the individual status codes includes the number of runs and the percentage of total runs with that status code. The total number of results may be greater than the number of machines reporting results if a test run was attempted more than once on that machine. A test run is Incomplete if the run does not include an End Run diagnostic custom action. The user is able to drill down to a list of machines with a specific status code or to a list of all machines for the job.

Any test that cause failures are also displayed, along with the number of times the test failed and the percentage of the total failures this test accounted for. The user is able to drill down to see a list of machines that failed a particular test.

Passed/Failed/Warnings/All Results

The Passed, Failed, Warnings and All Results pages all display a list of machines whose status codes meet the specified code. The All Result page groups the machines by status code. The Job name is displayed at the top of the page. For each machine, the machine name and date and time of the run are displayed. The user is able to drill down and see the individual test results on the Run Details page.

Tests that Caused Failures

On the Tests that Caused Failures page, any machine that failed the specified test is listed. For each machine the data/time of the run, the source machine name, the active user and status are displayed. From a machine, the user can is able to drill down and see all the individual test results for that machine on the Run Details page.

Run Details

The Run Details page displays the results of the individual test results that make up the diagnostic run. The Job name, MSI path, and date and time of the run are listed at the top to the page.

For each test, the test name, test message, status and whether there are additional details about the test are listed. The test message more detailed information about a test. If there are additional details about a test the user can drill down and see the detail on the message details page.

Test Details

On the message details page the user can view any detail information about a specific test. This generally lists the results for every check that the diagnostic test performed. These results were summarized on the Run Details page. The Job name and machine name are listed at the top of the page, followed by the detail information. The detailed information displayed varies depending on the related database table.

The new Preflight functionality differs from the testing compilation mode in WiseScript in several ways:
1) First, code is not compiled to create an MSI to create an MSI. Instead, an existing MSI is modified by inserting diagnostic custom actions into the existing MSI file. This allows a Preflight analysis to be performed on any MSI created by any tool;
2) Instead of creating status MIF files to report the status of the test, the results of the Preflight test are sent to a central server where the information is aggregated and made available for reporting; and
3) When a preflight MSI runs no changes are made to the target machine, no files or registry keys are created then removed.

The entire preflight process is integrated in the Package Studio User Interface including generating preflight packages and viewing the reports, so it is very easy to perform these tests. Perhaps the greatest difference involves the process of sending the results of the preflight test through SOAP to a server and storing these results in a SQL Server database for later reporting.

We claim:

1. A method of pretesting software to determine how it will install on a target machine, comprising the steps of:
providing an application program package;
instrumenting the package with one or more diagnostic actions operative to generate install information;
storing the install information in a database;
simulating an install of the instrumented package on a target machine including the execution of the diagnostic actions; and
analyzing the install information to determine the quality of the install prior to an actual install of the application.

2. The method of claim 1, further including the step of removing one or more components from the package if not important to the install or execution of the diagnostic actions.

3. The method of claim 1, wherein the step of instrumenting is carried out manually or automatically.

4. The method of claim 1, wherein the database is an SQL database.

5. The method of claim 1, wherein the install information is generated in XML or other mark-up language.

6. The method of claim 1, wherein the install information is stored on a server.

7. The method of claim 1, further including the step of analyzing the install information using a query language.

8. The method of claim 1, including the step of implementing the diagnostic actions in a DLL.

9. The method of claim 1, wherein the diagnostic actions use a Windows® installer API and calls to perform the actions.

10. The method of claim 1, further including the step of adding one or more additional diagnostic actions to existing actions.

11. The method of claim 1, wherein the step of analyzing the install information includes the steps of:
presenting the information with a course level of detail; and
allowing a user to select certain of the information for a finer level of detail.

12. A system for pretesting an MSI package to determine how it will install on a target machine, comprising:
a set of diagnostic actions enabling a user to create an instrumented package to return information regarding the status of an install;
a deployment tool operative to simulate an install of the instrumented package on one or more target machines, including the execution of the diagnostic actions;
a reporting system allowing a user to analyze the information returned by the execution of the diagnostic actions; and
a database for receiving the information returned by the execution of the diagnostic actions.

13. The system of claim 12, further including an instrumentation analyzer operative to examine the instrumented package and remove one or more components if not important to the install or execution of the diagnostic actions.

14. The system of claim 12, wherein the database is an SQL database.

15. The system of claim 12, wherein the reporting system further includes a server enabling a user to analyze the information using a query language.

16. A computer-readable medium having stored thereon the system of claim 12.

17. A computer-readable medium having stored thereon:
a set of diagnostic actions enabling a user to create an instrumented application package operative to return information regarding the status of an install of the package;
a deployment tool operative to simulate an install of the instrumented package on one or more target machines, including the execution of the diagnostic actions; and
a reporting system allowing a user to analyze the information returned by the execution of the diagnostic actions.

18. The computer-readable medium of claim 17, further including an instrumentation analyzer operative to examine the instrumented package and remove one or more components if not important to the install or execution of the diagnostic actions.

19. The computer-readable medium of claim 17, wherein the reporting system further includes a database for receiving the information returned by the execution of the diagnostic actions.

20. The computer-readable medium of claim 17, wherein the reporting system further includes a server enabling a user to analyze the information using a query language.
